(19) United States
(12) Patent Application Publication
(10) Pub. No.: US 2013/0117232 A1
(43) Pub. Date: May 9, 2013

(54) SNAPSHOTS OF DATABASE MODELS

(71) Applicants: Craig Lee, Issaquah, WA (US); Haroon Ahmed, Bellevue, WA (US)

(72) Inventors: Craig Lee, Issaquah, WA (US); Haroon Ahmed, Bellevue, WA (US)

(73) Assignee: MICROSOFT CORPORATION, Redmond, WA (US)

(21) Appl. No.: 13/292,829

(22) Filed: Nov. 9, 2011

(51) Int. Cl. G06F 7/00

(52) U.S. Cl. 707/639; 707/E17.044; 707/E17.127

(57) ABSTRACT

Methods, systems, and computer program products are provided for capturing snapshots of database models. Metadata of a database model is captured. A database model snapshot object is generated based on the captured metadata. The generated database model snapshot object is transportable, extensible, secure, and human readable. Furthermore multiple database model snapshot objects may be compared to each other to determine differences in database models in different database systems, to track how a database model of a database system is changing over time, to track how database source projects evolve over time and/or for other uses.

### BACKGROUND

A database model defines the infrastructure of a database and determines how data may be organized, manipulated, and stored in the database. For instance, a database model may define tables, views, functions, procedures, and/or further objects associated with a database. It may also include a set of fixed or slow moving data (for e.g. list of states in US, or gender types etc.) that may be used as reference data for other user operational data in the database. A database application may be created that is a running instance of a database model. The created database application contains the tables, views, reference data and other objects defined by the database model. The tables of the database application may be filled with data and/or otherwise interacted with by users.

The structure of a database model implemented by a database application may be modified over time (e.g., by developers, database administrators, etc.), such as by adding tables, adding columns, etc. As such, the structure of the database model implemented by the database application may diverge from the structure of the database model originally used to create the database application.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for capturing snapshots of database models. A captured database model snapshot contains the information that defines the structure of the database model from which it is captured. The captured database model snapshot may be generated to have the form of a file system object (e.g., a file), and its contents may be formatted in a generic, human readable form.

In one implementation, a method for capturing a snapshot of a database model is provided. Metadata for the database model is captured. A database model snapshot object is generated based on the captured metadata. The database model snapshot object is generated to be transportable, extensible, secure, and human readable.

Additionally, multiple database model snapshot objects may be compared to each other. The database model snapshot objects may be compared to determine differences in database models in different database systems, to track how a database model of a particular database system is changing over time, and/or for other uses.

In another implementation, a database model snapshot generator is provided. The database model snapshot generator includes a metadata capture module and a snapshot object generator. The metadata capture module captures metadata for the database model. The snapshot object generator generates a database model snapshot object based on the captured metadata. The generated database model snapshot object is transportable, extensible, secure, and human readable. The database model snapshot generator may further include a snapshot comparator. The snapshot comparator may compare multiple database model snapshot objects to each other.

Computer program products containing computer readable storage media are also described herein for generating database model snapshot objects and comparing database model snapshots, as well as for additional embodiments described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a database model, according to an example embodiment.

FIG. 2 shows a block diagram of a database model snapshot generator that obtains database model metadata from example types of database systems, according to embodiments.

FIG. 3 shows a flowchart providing a process for generating a snapshot of a database model, according to an example embodiment.

FIG. 4 shows a block diagram of a computer system configured to generate and process database model snapshots, according to an example embodiment.

FIG. 5 shows a flowchart providing a process for comparing database models, according to an example embodiment.

FIG. 6 shows a block diagram of a development database system and a production database system that are each configured to compare database models, according to an example embodiment.

FIG. 7 shows a block diagram of a computer system configured to post-process database model snapshots, according to an example embodiment.

FIG. 8 shows a flowchart providing a process for generating a database model using database model snapshots and custom code, according to an example embodiment.

FIG. 9 shows a block diagram of a database system configured to generate a database model using snapshots and custom code, according to an example embodiment.

FIG. 10 shows a diagram of an environment in which database model snapshots are communicated between various personnel, according to an example embodiment.

FIG. 11 shows a block diagram of a database model snapshot object that is usable by a variety of different tools, according to an example embodiment.

FIG. 12 shows a block diagram of an example computer that may be used to implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments of the present invention are described as follows. It noted that any section/subsection headings provided herein are not intended to be limiting. Embodiments are described throughout this document, and any type of embodiment may be included under any section/subsection.

### II. Example Embodiments

A database model defines the infrastructure of a database and determines how data may be organized, manipulated, and stored in a database system. A database model may define tables, views, functions, procedures, and/or further objects, and may include reference data that may be stored in tables. A database application may be created that is an instance of a database model. The created database application contains the tables, views, etc., defined by the database model. The tables, views, etc. of the database application may be filled with data and/or otherwise interacted with by users. Furthermore, the structure of the database model implemented by the database application may be modified (e.g., by adding columns to tables, etc.). As such, the structure of the database model implemented by the database application may diverge from the structure of the database model originally used to create the database application.

Typically, the structure of a database model in a moment in time may not be directly captured. For instance, when a running database application is copied, the operational data entered by users into the database application is copied along with the structure of the database model. A convenient way of just capturing the database model in a secure and compliant fashion at a particular point in time does not conventionally exist. Because of this it is difficult to analyze and communicate database models as they change over time.

Accordingly, embodiments for capturing snapshots of database models are provided. In embodiments, a snapshot of a database model may be captured to have the form of a file system object (e.g., a file or other file system object), referred to as database model snapshot object. The database model snapshot object may be transportable, human readable, and extensible. For instance, the database model snapshot object may be considered to be transportable because it is in object form (e.g., a file) that may be electronically stored and/or transferred between users and/or between applications using electronic communication techniques (e.g., file transfer protocols, email, network communications such as Internet protocol (IP) communications, wireless communications, etc.). The database model snapshot object may be compressible (e.g., compressed into a ZIP file, etc.) to enhance transportability. The database model snapshot object may be considered to be human readable because its contents are in a human readable form (e.g., text) such as the code of a programming language. The database model snapshot object may be normalized into a common format to enhance human readability and subsequent processing. The database model snapshot object may be considered to be extensible because it is may extended by being edited (e.g., by humans). For instance, in an embodiment, the database model snapshot object may be coded in extensible markup language (XML). The database model snapshot object may be considered to be secure because its contents are human readable, and may be analyzed (automatically and/or manually) and edited (if necessary) to remove sensitive information.

Furthermore, the database model snapshot object may be exclusive of operational data. “Operational data” generally refers to data that is entered by users into a database application (e.g., entered into rows of tables), which tends to be frequently changing data (e.g., sales order information, corporate data, etc.). Because a database model snapshot object is exclusive of operational data, the database model snapshot object is more compact, and may be more easily compared against other database model snapshot objects. In some embodiments, however, operational data may be associated with an database model snapshot object.

Embodiments provide various advantages and benefits. For instance, in some environments, not all users have access to all sources of a database model due to security and other policies. According to an embodiment, a database model snapshot can be taken of the database model by a privileged user and made available to those users that are less privileged as a proxy. An example of such an environment is the sharing of the database model snapshot from a production environment (e.g., an environment where instances of the database model are installed in database applications and used by users) back to the development team that developed (and may further develop) the database model. Furthermore, in an embodiment, it may be beneficial to have the ability to capture database model snapshots at various stages of the evolution of a database model to provide improved telemetry and a new dimension of richer tooling.

A database system includes a database model, a database management system, and a database (that contains data). Types of database models for database systems include the relational model, the flat model, the hierarchical model, the object-relational model, etc. The data model for a database system defines the way data is structured in the database of the database system, as well as defining operations that can be performed on the data.

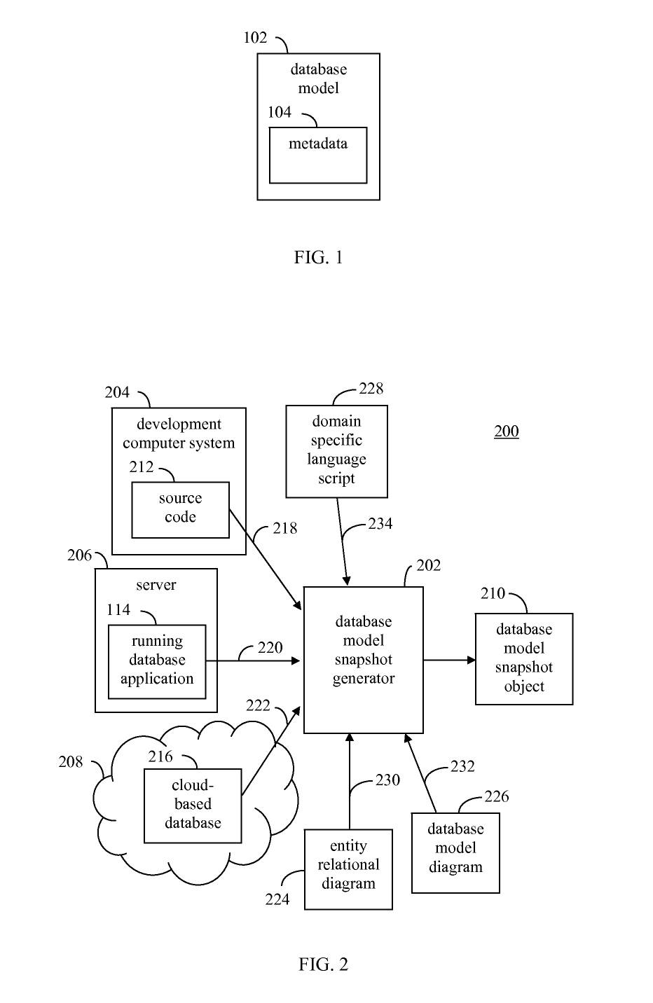

As such, a database model defines the infrastructure of a database and determines how data may be organized, manipulated, and stored in a database system. A database model may be represented by metadata. Metadata for a database model is defined as the tables, views, functions, procedures, and/or further database mode objects of the database model, and includes any reference data of the database model. For instance, FIG. 1 shows a block diagram of a database model 102, according to an example embodiment. As shown in FIG. 1, database model 102 includes metadata 104. Metadata 104 includes all data used to define the structure of database model 102, including all data used to install a database application based on database model 102. For instance, metadata 104 may include data that defines the one or more of any tables, views, functions, procedures, and/or further objects that are included in database model 102, as well as any reference data of database model 102. “Reference data” (as distinguished from operational data) may have the form of one or more reference data tables included in metadata 104 by a developer of database model 102, and generally refers to fixed or slow changing data (e.g., names of the 50 states of the United States, the male and female gender values, etc.). “Reference data” typically includes one or more valid lists of data values for data points that users may insert into the tables of a database application created based on database model 102.

Embodiments enable a user to capture snapshots of a database model in different environments and at different stages of the database model lifetime. Examples of sources of a database model from which a database model snapshot may be captured include, but are not limited to: a running database server, a development source code project, a set of domain specific language (DSL) scripts, and a variety of modeling tools.

For instance, FIG. 2 shows a block diagram of a communication environment 200 in which a database model snapshot generator 202 obtains database model metadata from example types of database systems, according to embodiments. Database model snapshot generator 202 of FIG. 2 is configured to generate snapshots for database models based on received metadata. As shown in FIG. 2, database model snapshot generator 202 may receive metadata from various database systems, including database systems and/or code at a development computer system 204, a server 206, a network cloud 208, an entity relational diagram 224, a database model diagram 226, and a domain specific language script 228. Database model snapshot generator 202 may generate a database model snapshot object 210 for the metadata received for a corresponding database model. In an embodiment, database model snapshot generator 202 may be implemented in development computer system 204, server 206, or one or more computer systems of network cloud 208, or may be implemented in another computer system that accesses development computer system 204, server 206, and/or network cloud 208 over one or more networks (e.g., a local area network (LAN), a wide area network (WAN), or a combination of communication networks, such as the Internet).

For example, development computer system 204 may be a computer system used by one or more developers to develop a database model. For instance, the developer(s) may code the database model in the form of source code 212 that may include programming code of any suitable programming language, such as SQL (structured query language). Database model snapshot generator 202 may receive metadata 218 from source code 212 that defines the database model coded by source code 212. For instance, in an embodiment, database model snapshot generator 202 may parse source code 212 to extract metadata 218, or may receive/extract metadata 218 in another manner from source code 212.

Server 206 may be a computer system in which a running database application 114 is installed. Running database application 114 is a running instance of a database model installed at server 206. The database model of running database application 114 may potentially have been modified since being installed. For instance, one or more database administrators (DBAs) may have installed running database application 114, and may manage/administer running database application 114 for one or more users. The DBA(s) may handle problems with running database application 114, and may make modifications to the database model of running database application 114 to accommodate users (e.g., by adding columns, removing columns, adding tables, etc.). Database model snapshot generator 202 may receive metadata 220 from running database application 114 that defines its database model. For instance, in an embodiment, database model snapshot generator 202 may parse one or more files associated with running database application 114 to receive metadata 220, or may receive/extract metadata 220 in another manner from running database application 114.

Network cloud 208 is a cloud-based network that enables a cloud-based database 216 to be provided to user computers as a service. Cloud-based database 216 may be a database application operating in a computer system of network cloud 208 as a running instance of a database model. The database model of cloud-based database 216 may potentially have been modified since being installed (e.g., by developers, by DBAs, etc.). Database model snapshot generator 202 may receive metadata 222 from cloud-based database 216 that defines its database model. For instance, in an embodiment, database model snapshot generator 202 may parse one or more files associated with cloud-based database 216 to receive metadata 222, or may receive/extract metadata 222 in another manner from cloud-based database 216.

Entity relational diagram 224 (also known as an entity relationship diagram) is a diagram that represents a database in terms of its database model objects and their relationships. For instance, entity relational diagram 224 may be a diagram that represents a database model in the form of tables, views, functions, procedures, reference data, and/or other database model objects as entities, and provides links (e.g., arrows) between the database model objects to indicate their relationships. Database model snapshot generator 202 may receive and analyze entity relational diagram 224 to identify the entities (database model objects) therein, and to determine their indicated relationships, as metadata 230.

Database model diagram 226 is another type of diagram that represents a database in terms of its database model objects and their relationships. For instance, database model diagram 226 may be a diagram that represents database model objects and their relationships in an object-oriented model diagram, a network model diagram, a flat file model diagram, a hierarchical model diagram, etc. Database model snapshot generator 202 may receive and analyze database model diagram 226 to identify the database model objects and their relationships, as metadata 232.

Domain specific language script 228 may be a script coded according to any domain specific language (e.g., HTML (hypertext markup language), etc.). The code defines the database model (similarly to source code 212 described above). For instance, in an embodiment, database model snapshot generator 202 may parse domain specific language script 228 to extract metadata 234, or may receive/extract metadata 234 in another manner from domain specific language script 228.

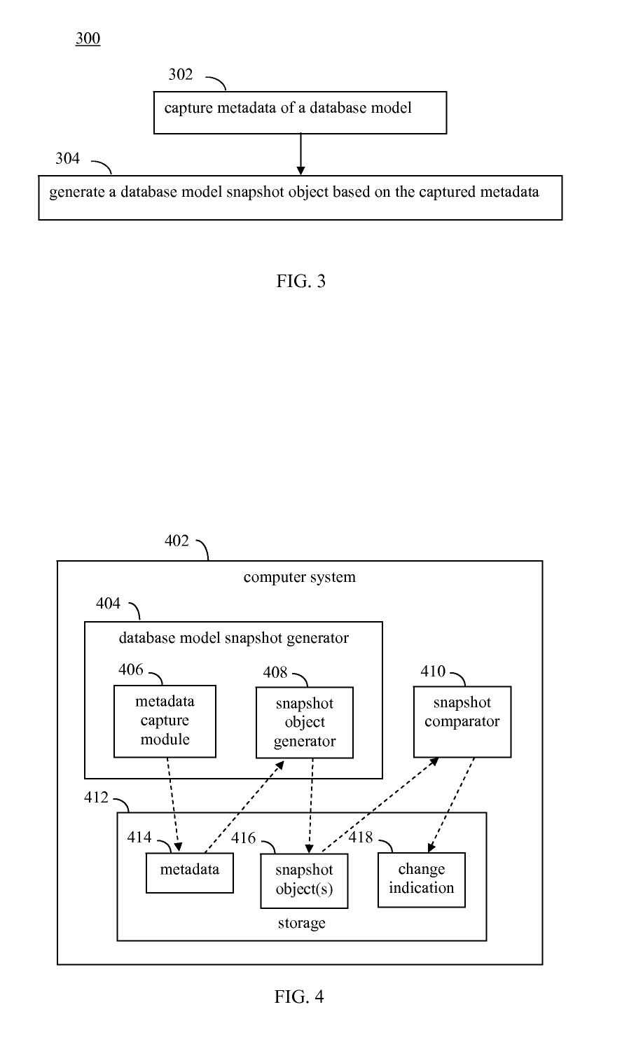

Database model snapshot generator 202 may be configured to obtain metadata and generate database model snapshots in various ways. For instance, FIG. 3 shows a flowchart 300 providing a process for generating a snapshot of a database model, according to an example embodiment. In an embodiment, flowchart 300 may be performed by database model snapshot generator 202 of FIG. 2. Flowchart 300 is described as follows with reference to FIG. 4. FIG. 4 shows a block diagram of a computer system 402 that includes a database model snapshot generator 404, according to an example embodiment. Database model snapshot generator 404 of FIG. 4 is an example embodiment of database model snapshot generator 202 of FIG. 2. As shown in FIG. 4, computer system 402 includes database model snapshot generator 404, storage 412, and a snapshot comparator 410. Furthermore, as shown in FIG. 4, database model snapshot generator 404 includes a metadata capture module 406 and a snapshot object generator 408. Further structural and operational embodiments will be apparent to persons skilled in the relevant art(s) based on the following discussion regarding flowchart 300 and computer system 400.

Flowchart 300 begins with step 302. In step 302, metadata of a database model is captured. For instance, in an embodiment, metadata capture module 406 of database model snapshot generator 404 in FIG. 4 may be configured to capture metadata of a database model. Metadata capture module 406 may receive metadata from any type of database model, including metadata 218 of source code 212 at development computer system 204 (FIG. 2), metadata 220 of running database application 114 at server 206, metadata 222 of cloud-based database 216 in network cloud 208, etc. Furthermore, metadata capture module 406 may receive metadata from other database models, including modeling tools, domain specific language scripts, etc.

Metadata capture module 406 may capture all metadata used to define a database model. For instance, metadata capture module 406 may capture metadata defining one or more tables of a database model, such as metadata that identifies the one or more tables (e.g., by table name or other identifier), that identifies one or more columns of each table (e.g., by column name or other identifier), etc. Metadata capture module 406 may capture metadata defining one or more views of a database model. A view is a projection that shows a portion (processed or un-processed) of the available data of one or more tables. For instance, a view may show a portion of the available columns, a filtered portion of the available data, an aggregation of the available data, and/or other processed or un-processed portion of the available data, and one or more such views may be defined in the captured metadata. Metadata capture module 406 may capture metadata defining one or more functions of a database model. A function (e.g., an equation) processes available data to return a value (e.g., by computing a value to be included in rows of a column), and one or more such functions may be defined in the captured metadata. Metadata capture module 406 may capture metadata defining one or more procedures of a database model. A procedure defines a workflow that typically implements business logic, and one or more such procedures may be defined in the captured metadata. Metadata capture module 406 may also capture all reference data associated with a database model. The captured reference data may have the form of one or more reference data tables.

As shown in FIG. 4, metadata capture module 406 may optionally store metadata captured for a database model in storage 412 as metadata 414. Metadata 414 may be stored in storage 412 in any form (e.g., as a data structure). Alternatively, metadata 414 may be provided directly to snapshot object generator 408 without being stored in storage 412.

Referring back to FIG. 3, in step 304, a database model snapshot object is generated based on the captured metadata. For instance, in an embodiment, snapshot object generator 408 may receive metadata 414 (from storage 412 or from metadata capture module 406), and may generate a database model snapshot object (e.g., database model snapshot object 210 of FIG. 2) based on metadata 414. For instance, in an embodiment, snapshot object generator 408 may convert metadata 414 for a database model into an extensible, normalized, and human readable form, which may be stored in a file or other object to form the database model snapshot object.

For instance, snapshot object generator 408 may convert metadata 414 into XML code. In an embodiment, snapshot object generator 408 may generate the database model snapshot object to contain the source database model serialized into XML and packaged in an OPC (open packaging convention) format. OPC is open packaging convention that is extensible and enables multiple file artifacts to be combined together into one file artifact. OPC contains necessary metadata to extract back the input source(s). OPC also allows features such as compression, digital signature, etc. (ZIP is an example of OPC format). Additional supporting artifacts may be provided in an OPC package in addition to a database model snapshot object XML file. Examples of such additional supporting artifacts include a Version.xml file, a Refactor.log file, etc.

In an embodiment, the generated database model snapshot object may include one or more document portions that correspond to different metadata components of metadata 414. The document portions may be generated in a standardized and human readable form. For instance, the generated database model snapshot object may include one or more types of human readable tags (e.g., for markup) or other labels corresponding to the different metadata components. For instance, a header tag may identify the generated database model snapshot object itself. Further tags/labels may indicate the type and locations of the different metadata components in database model snapshot object, such as tables, views, functions, procedures, and/or other metadata components, and reference data. Each of the different metadata components may be described in association with their tag/label in human readable text and in a standardized manner in generated database model snapshot object so that a person can read the description and understand the corresponding metadata component structure. For instance, in the generated database model snapshot object, a table may have a corresponding table tag/label that identifies the presence of the table, that provides a name/identifier of the table, that identifies the one or more columns of the table and their relative positions, that identifies relationships with other tables, etc. A view may have a corresponding view tag/label that identifies the presence of the view, that provides a name/identifier of the view, that identifies the one or more columns and/or other data included and/or processed in the view, etc. A function may have a corresponding function tag/label that identifies the presence of the function, that provides a name/identifier of the function, that shows the function, that identifies data manipulated by the function, that identifies where the output values of the function are positioned in tables, etc. Further metadata components may be identified and described in the generated database model snapshot object in corresponding ways. Furthermore, the generated database model snapshot object may include one or more comments (e.g., delineated by markers such as “<!−−” and “−−!>”) that may be used to further describe portions of the generated database model snapshot object to persons, as desired.

As shown in FIG. 4, snapshot object generator 408 may optionally store one or more database model snapshot objects in storage 412 as snapshot object(s) 416 that were generated based on metadata 414 for one or more database models.

Storage 412 may include one or more of any type of storage mechanism to store data and/or code, including a magnetic disk (e.g., in a hard disk drive), an optical disc (e.g., in an optical disk drive), a magnetic tape (e.g., in a tape drive), a memory device such as a RAM device, etc., and/or any other suitable type of storage medium. Computer system 402 may be any type of stationary or mobile computing device, including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a netbook, etc.), a smart phone (e.g., an Apple iPhone, a Google Android™ phone, a Microsoft Windows® phone, etc.), or other type of computing device.

Note that FIG. 4 is provided for purposes of illustration, and in other embodiments, database model snapshot generator 404 may be implemented in other ways, as would be known to persons skilled in the relevant art(s) from the teachings herein.

The following subsections further describe these embodiments and embodiments for comparing database model snapshots, post-processing database model snapshots, deploying data models based on database model snapshots, as well as further embodiments

### A. Example Embodiments for Comparing Database Model Snapshots

In embodiments, generated database model snapshot objects may be compared to each other for various reasons. For instance, snapshots of a database model may be generated at different stages of a lifetime of the database model that may be compared to each other to show changes made to the database model over time, for development purposes, for testing purposes, etc. The snapshots may be stored for archival purposes, as well. For instance, snapshots of a database model of a running production database system may be generated at different times, and compared to each other, to show changes made to the running production database system. Alternatively, snapshots of a database model of a development database system may be generated at different times, and compared to each other, to show changes made to the database model in development. In another example, a snapshot of a database model of a running production database system may be generated and compared to a snapshot of the database model at a development database system, to show changes made at either the running production database system or the development database relative to the other.

In an embodiment, snapshot comparator 410 of FIG. 4 may be configured to perform comparisons of database model snapshot objects to enable their differences to be determined For instance, snapshot comparator 410 may receive one or more of snapshot object(s) 416 from storage 412 and/or from other computer systems, and may compare them, to generate corresponding change indications 418. A change indication 418 indicates differences between first and second compared database model snapshot objects. As shown in FIG. 4, snapshot comparator 410 may optionally store a generated change indication 418 in storage 412.

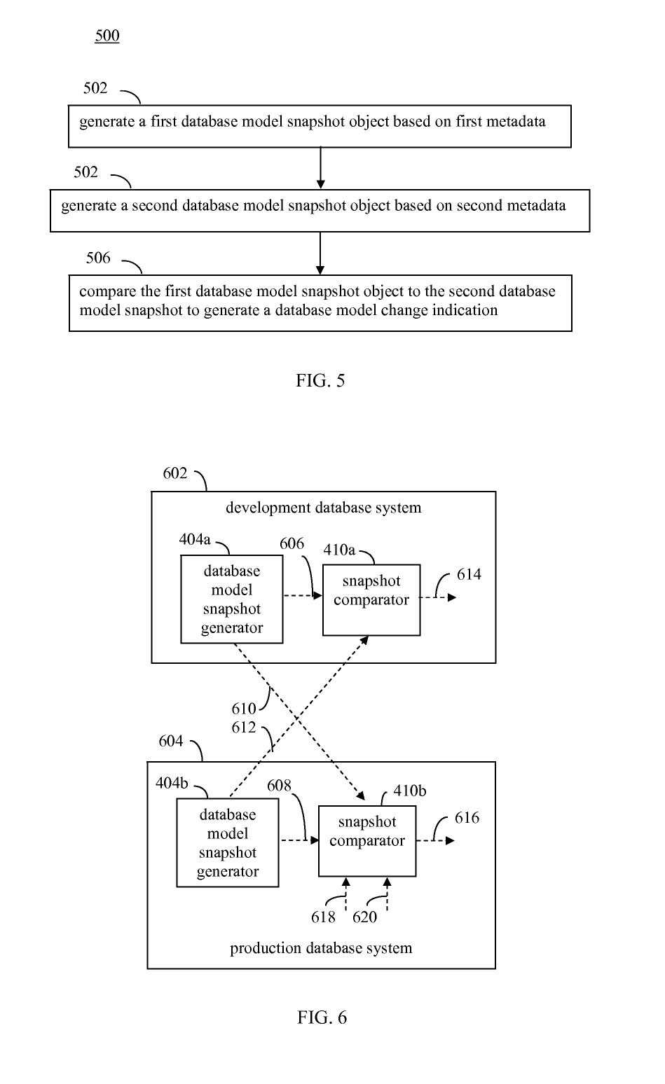

Snapshot comparator 410 may perform such comparisons in various ways. For instance, FIG. 5 shows a flowchart 500 providing a process for comparing database models, according to an example embodiment. In an embodiment, flowchart 500 may be performed by database model snapshot generator 404 and snapshot comparator 410 of FIG. 4. Further structural and operational embodiments will be apparent to persons skilled in the relevant art(s) based on the following discussion regarding flowchart 500.

Flowchart 500 begins with step 502. In step 502, a first database model snapshot object is generated based on first metadata. For example, as described above, database model snapshot generator 404 (FIG. 4) may generate a first database model snapshot object (e.g., which may be stored in storage 412 in snapshot object(s) 416. Alternatively, a different database model snapshot generator may generate the first database model snapshot object.

In step 504, a second database model snapshot object is generated based on second metadata. For example, as described above, database model snapshot generator 404 (FIG. 4) may generate a second database model snapshot object (e.g., which may be stored in storage 412 in snapshot object(s) 416. Alternatively, a different database model snapshot generator may generate the second database model snapshot object.

In step 506, the first database model snapshot object is compared to the second database model snapshot to generate a database model change indication. In an embodiment, snapshot comparator 410 (FIG. 4) receives and compares the first and second database model snapshot objects to generate change indication 418. Change indication 418 indicates the differences between the first and second database model snapshot objects.

For instance, in one embodiment, snapshot comparator 410 may be configured to perform a document compare, similar to a document compare that may be performed by a word processing tool (e.g., such as Microsoft® Word developed by Microsoft Corporation of Redmond, Washington). In such case, change indication 418 may have the form of a human readable document that shows the common contents of the first and second database model snapshots, and highlights any differences between the contents of the first and second database model snapshot objects. Alternatively, change indication 418 may just show the differences between the contents of the first and second database model snapshot objects. In another embodiment, snapshot comparator 410 may perform a more sophisticated comparison of the first and second database model snapshot objects than a simple document compare, generating change indication 418 to provide additional information and/or analysis that describes the differences between the first and second database model snapshot objects in greater detail.

As described above, snapshot comparator 410 may be configured to compare database model snapshot objects generated at various sources. For instance, FIG. 6 shows a block diagram of a development database system 602 and a production database system 604 that are each configured to compare database models, according to an example embodiment. As shown in FIG. 6, development database system 602 includes a database model snapshot generator 404a and a snapshot comparator 410a, and production database system 604 includes a database model snapshot generator 404b and a snapshot comparator 410b.

Development database system 602 is a database system (e.g., a database development application) implemented in one or more computer systems that is used by one or more developers for development purposes (e.g., generating a new database model to be used in production database systems, performing modifications to existing database models, etc.). Production database system 604 is a database system (e.g., a working database application) implemented in one or more computer systems that is administered by one or more DBAs and used by one or more users to store/manage their data. Production database system 604 may have a database model that originated from the database model of development database system 602. Either or both of the database models of development database system 602 and production database system 604 may have been changed since that time.

In embodiments, it may be desirable to capture database model snapshots of the database models of development database system 602 and/or production database system 604 to be compared to each other to determine changes that may have been made. For instance, in one example, database model snapshot generator 404a may generate a current database model snapshot object 606 for the database model of development database system 602 (e.g., by capturing metadata of the database model of development database system 602, etc., as described above). As shown in FIG. 6, snapshot comparator 410a may receive current database model snapshot object 606. Snapshot comparator 410a may compare current database model snapshot object 606 to a previously generated database model snapshot object (e.g., stored in storage 412 in FIG. 4) for development database system 602 to generate a database model change indication 614 that indicates a database model change in development database system 602. Such a comparison may be performed for various purposes, such as to show progress being made in developing the database model of development database system 602, etc.

In another example, database model snapshot generator 404b may generate a current database model snapshot object 608 for the database model of production database system 604 (e.g., by capturing metadata of the database model of or production database system 604, etc., as described above). As shown in FIG. 6, snapshot comparator 410b may receive current database model snapshot object 608. Snapshot comparator 410b may compare current database model snapshot object 608 to a previously generated database model snapshot object (e.g., stored in storage 412 in FIG. 4) for production database system 604 to generate a database model change indication 616 that indicates a database model change in production database system 604. Such a comparison may be performed for various purposes, such as to document changes made to the database model of production database system 604, etc.

In another example, database model snapshot generator 404a may generate a database model snapshot object 606 for the database model of development database system 602. Furthermore, database model snapshot generator 404b may generate a database model snapshot object 612 for the database model of production database system 604. As shown in FIG. 6, snapshot comparator 410a may receive database model snapshot object 606 generated locally and may receive database model snapshot object 612 from production database system 604. Snapshot comparator 410a may compare database model snapshot object 606 to database model snapshot object 612 to generate a database model change indication 614 that indicates a difference in the database models of development database system 602 and production database system 604. Such a comparison may be performed for various purposes, such as to show changes made in developing the database model of development database system 602 that may desirable to provide to production database system 604, to show changes made in the database model of production database system 604 that may be desirable to work into the database model of development database system 602, etc.

In a similar fashion, database model snapshot generator 404b may generate a database model snapshot object 608 for the database model of production database system 604. Furthermore, database model snapshot generator 404a may generate a database model snapshot object 610 for the database model of development database system 602. As shown in FIG. 6, snapshot comparator 410b may receive database model snapshot object 608 generated locally and may receive database model snapshot object 610 from development database system 602. Snapshot comparator 410b may compare database model snapshot object 608 to database model snapshot object 610 to generate a database model change indication 616 that indicates a difference in the database models of development database system 602 and production database system 604. Such a comparison may be performed for various purposes, such as to show changes made in developing the database model of development database system 602 that may desirable to provide to production database system 604, to show changes made in the database model of production database system 604 that may be desirable to work into the database model of development database system 602, etc.

In still another example, database model snapshot generator 404b may generate current database model snapshot object 608 for the database model of production database system 604. As shown in FIG. 6, snapshot comparator 410b may receive current database model snapshot object 608. Furthermore, as shown in FIG. 6, snapshot comparator 410b may receive first and second database model snapshot objects 618 and 620. First and second database model snapshot objects 618 and 620 a different snapshot versions of another database model (e.g., a deployment database model). Snapshot comparator 410b may compare current database model snapshot object 608 to first database model snapshot object 618 to generate database model change indication 616 that indicates a difference between the database model of production database system 604 and the other database model. If change indication 616 indicates that there are no differences between the database models, second database model snapshot object 620 may be selected to be deployed (installed) at production database system 604. In this example, the comparison may be performed as a pattern to guarantee that a new database model version (e.g., second database model snapshot object 620) is only deployed if the target database has not drifted away from a previous database model version (e.g., first database model snapshot object 618).

### B. Example Embodiments for Post-Processing of Database Model Snapshots

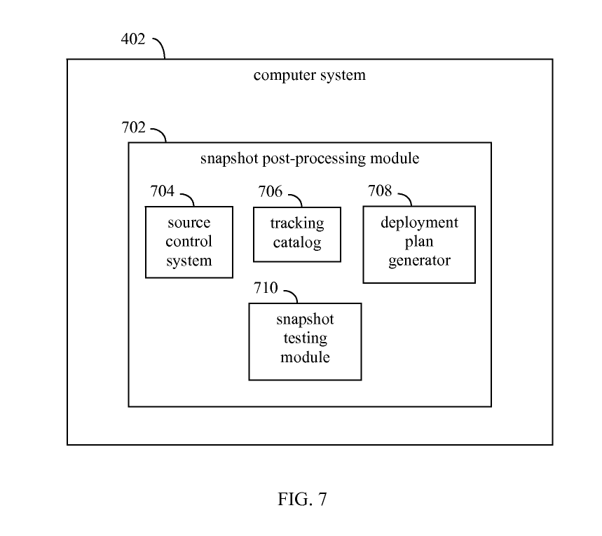

In embodiments, generated database model snapshot objects and snapshot change indications may be used in various ways, including for archival purposes, version tracking, history tracking, deploying data model updates, testing, etc. For instance, FIG. 7 shows a block diagram of computer system 402, according to an example embodiment. As shown in FIG. 7, computer system 402 includes a snapshot post-processing module 702. Snapshot post processing module 702 is configured to enable post-processing of database model snapshots. As shown in FIG. 7, snapshot post-processing module 702 includes a source control system 704, a tracking catalog 706, a deployment plan generator 708, and a snapshot testing module 710. Any one or more of source control system 704, tracking catalog 706, deployment plan generator 708, and/or snapshot testing module 710 may be present in embodiments.

For instance, in the case where a database model snapshot object is generated for a database model of a development database system, the database model snapshot object may be checked into source control system 704. For instance, source control system 704 may include storage for storing the database model snapshot object, and may indicate a time/date at which the database model snapshot object was checked in/registered (e.g., in a catalog, table, or other data structure). Source control system 704 may maintain the database model snapshot object, as well as subsequent database model snapshot objects generated for the database model of the development database system for purposes of version and/or history tracking of the database model.

In the case where a database model snapshot object is generated for a database model of a production database system, the database model snapshot object may be checked into tracking catalog 706. The database model snapshot object may optionally be stored in storage associated with tracking catalog 706. Tracking catalog 706 may include a table, list, or other data structure stored in storage, and may indicate a time/date at which the database model snapshot object was checked in/registered. Tracking catalog 706 may maintain information regarding the database model snapshot object, as well as subsequent database model snapshot objects generated for the database model of the production database system for purposes of visibility, version, and/or history tracking of the database model.

In an embodiment, it may be desirable to test database model snapshot objects. In such case, snapshot testing module 710 may be present. Snapshot testing module 710 may receive and perform offline testing on a database model snapshot object, and generate corresponding test results. Any type of testing and number of tests may be performed on a database model snapshot object, including validity testing, testing for security violations (e.g., checking whether particular sensitive columns/tables are present in a data model), testing for legal requirements (e.g., checking whether legal requirements for contents of a data model are being met), testing for business requirements, and/or other types of testing.

As described above, change indications (e.g., change indication 418 of FIG. 4, etc.) can be generated by comparing different database model snapshots. The change indications may indicate differences between data models, and therefore may be used to generate a plan for modifying a data model to include one or more features of another data model. In such case, deployment plan generator 708 may be present. Deployment plan generator 708 may be configured to generate a deployment plan based on a database model change indication. For instance, deployment plan generator 708 may determine one or more changes between first and second database model snapshot objects indicated in a change indication, and for each change, may generate instructions for modifying a database model corresponding to one of the first and second database model snapshot objects to include the change(s) that are lacking in the database model. For instance, the deployment plan may add features to the metadata of the database model, may remove features from the metadata of the database model, may modifying existing features of the metadata of the database model, and/or may modify the metadata of the database model in other ways. In one example, deployment plan generator 708 may generate a deployment plan for upgrading a database model version in a production database system to a current staged version in development. In another example, deployment plan generator 708 may generate a deployment plan for modifying a database model in development database system to incorporate changes made to the database model of a production database system.

C. Example Embodiments for Deploying a Database Model with Custom Scripts

In a database model driven development world, the act of deployment of a database model is performed by a declarative deployment engine that typically receives a complete definition of a target model state (e.g., a currently installed database model) and a source model state (e.g., a database model to be applied to the target database model). These model states can be compared to each other, and an upgrade plan may be generated to update the target database model to match the source database model. For instance, the upgrade plan may be generated to make as minimal changes to the target database model as possible, so that it matches the source database model, but its operation is not otherwise interrupted. However, conventionally, there is no natural place in which imperative commands may be injected to influence the upgrade pipeline.

In embodiments, database model snapshots enable imperative commands to be injected in the deployment workflow/upgrade pipeline without sacrificing the richness of declarative deployment engines. For instance, in an embodiment, two snapshots of a database model may be captured. The first snapshot defines the state of the database model that imperative commands can be based on (e.g., may be applied to). The imperative commands may be implemented in a post deployment script to the first snapshot. This post deployment script causes a change to the database model state as well as any other desired imperative commands. The second snapshot captures the state of first snapshot and the imperative commands, and any other additional changes to the database model.

Upon deployment, the first snapshot is deployed to the target database system (which may or may not include a target database model), followed by the deployment script; which is followed by the second snapshot. Because the second snapshot finds the state of the target database model updated with the first snapshot and the imperative commands of the deployment script, the second snapshot does not need to again apply any intersecting changes, and may continue with the subsequent changes. The deployment script provides a clearly defined place in the deployment workflow where users are enabled to influence the deployment pipeline with custom imperative commands.

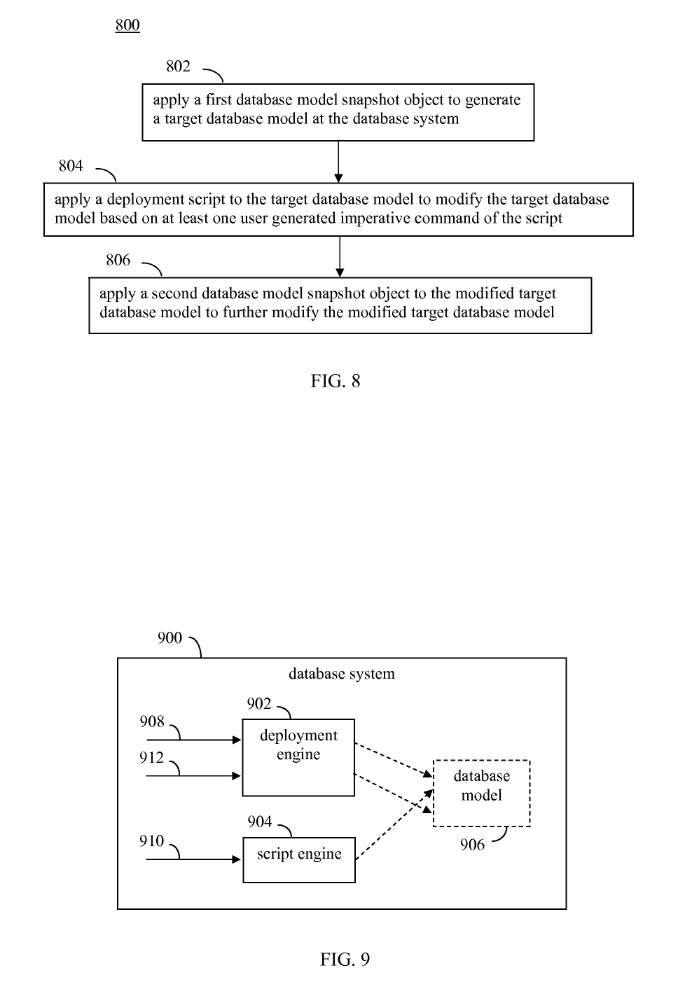

As such, in embodiments, database model snapshots in conjunction with user generated deployment scripts may be used to enhance the deployment of database models. For instance, FIG. 8 shows a flowchart 800 providing a process for generating a database model using database model snapshots and custom code, according to an example embodiment. Flowchart 800 is described as follows with reference to FIG. 9. FIG. 9 shows a block diagram of a database system 900 configured to generate a database model using snapshots and custom code, according to an example embodiment. As shown in FIG. 9, database system 900 includes a deployment engine 902 and a script engine 904. Database system 900 is a target system, and may be a production database system, a development database system, or any other database system. Further structural and operational embodiments will be apparent to persons skilled in the relevant art(s) based on the following discussion regarding flowchart 800 and database system 900.

Flowchart 800 begins with step 802. In step 802, a first database model snapshot object is applied to generate a target database model at the database system. For example, as shown in FIG. 9, a first database model snapshot object 908 is received at deployment engine 902 of database system 900. Deployment engine 902 is configured to apply first database model snapshot object 908 to generate a target database model 906 at database system 900. For instance, deployment engine 902 may be a commercially available or proprietary deployment engine for installing database models that is modified according to embodiments to install and/or update a database model from information in a received database model snapshot object. Note that first database model snapshot object 908 may be applied over a target database model already present in database system 900 to generate database model 906 or may be used to generate database model 906 as a new database model.

In step 804, a deployment script is applied to the target database model to modify the target database model based on at least one user generated imperative command of the script. For instance, as shown in FIG. 9, a deployment script 910 is received at script engine 904 of database system 900. Deployment script 910 may be configured in any manner, such as being a file or other file system object that includes one or more user provided imperative commands formulated according to a programming language (e.g., SQL, etc.). Script engine 904 is configured to apply deployment script 910 to database model 906 to modify database model 906 based on the included user generated imperative command(s). For instance, deployment script 910 may add, delete, and/or modify one or more tables, one or more table columns, one or more views, one or more functions, one or more procedures, and/or one or more other database model objects. Note that in an embodiment, script engine 904 may be separate from deployment engine 902, as shown in FIG. 9. In another embodiment, script engine 904 may be included in deployment engine 902.

In step 806, a second database model snapshot object is applied to the modified target database model to further modify the modified target database model. For example, as shown in FIG. 9, a second database model snapshot object 912 is received by deployment engine 902. Deployment engine 902 is configured to apply second database model snapshot object 912 to target database model 906 (which was modified by deployment script 910) to further modify database model 906 (e.g., adding one or more tables, columns, views, functions, procedures, etc.). Note that in embodiments, second database model snapshot object 912 may include the database model information included in first database model snapshot object 908, or may contain database model information that is not overlapping with first database model snapshot object 908. As such, any changes included in first database model snapshot object 908 and also contained in second database model snapshot object 912 are not applied during step 806.

### D. Example Advantages and Embodiments

Accordingly, embodiments are provided herein for generating database model snapshot based on database models, comparing database model snapshot to determined differences between them, and for performing further processing of database model snapshots and comparisons, including archiving database model snapshots, tracking versions of database model snapshots, tracking histories of database model snapshots, deploying data model updates, testing database model snapshots, etc. Such embodiments provide various advantages.

For instance, in some situations, database model snapshots may be used to work around real life constraints that are imposed by security restrictions, legal requirements, physical separation and other enterprise business policies with regard to database models. For instance, database model snapshots may be generated, and because they are human readable, may be analyzed and edited (if necessary) to remove sensitive information, to conform to legal requirements, to conform with business policies, etc.

Furthermore, database model snapshots enable improved visibility into database model evolution and its subsidiary tooling.

Still further, as described above, database model snapshots may be captured from various sources in embodiments. Examples of commonly available sources of database models include, but are not limited to: a running database server, a source code project, a set of domain specific language scripts, and a variety of modeling tools.

Furthermore, database model snapshots may be captured for a database model at different stages of the database model lifetime. Common instances where database model snapshots may be captured include, but are not limited to: taking database model snapshots of a production database, taking database model snapshots of a source code project at a developer box (e.g., computer system) at one or more development milestones, taking database model snapshots of a database model for testing and downstream development, etc.

As described above, the format characteristics of a database model snapshot (e.g., human readable, transportable, etc.) enables compliance with technical validation rules, security considerations, legal constraints and other business policies.

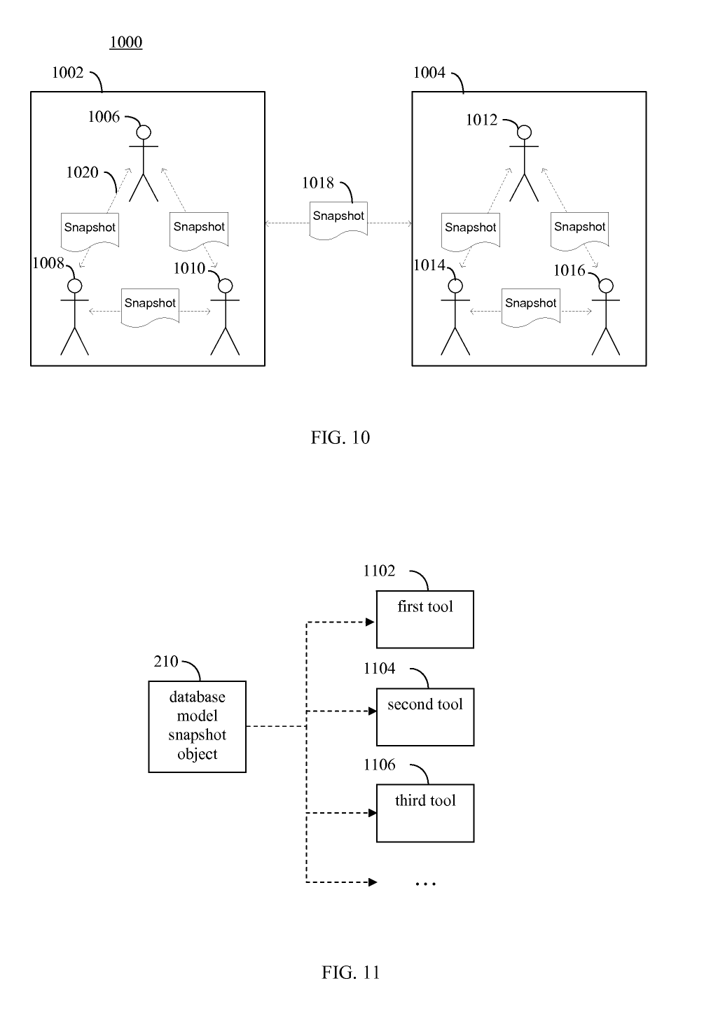

Database model snapshots may be used as a communication format across personnel and roles, because they are human readable and transportable. For instance, FIG. 10 shows a diagram of an environment 1000 in which database model snapshots are communicated between various personnel, according to an example embodiment. In FIG. 10, the various personnel are shown as persons 1006, 1008, and 1010 in a first group 1002 and persons 1012, 1014, and 1016 in a second group 1004. For instance, persons 1006, 1008, and 1010 may developers that are developing a database model, and used database model snapshots as means to communicate a database model under development. For example, persons 1006, 1008, and 1010 may be the same type of developer, and therefore may use database model snapshots to communicate database models within their team. Alternatively, persons 1006, 1008, and 1010 may be different types of developers, and may use database model snapshots to communicate database models to upstream and/or downstream developers. For instance, in one example, person 1006 may be a member of a database development team who communicates a database model snapshot 1020 to a downstream component developer, such as person 1008, who may be a member of a web development team.

Furthermore, database model snapshots may be used to communicate database model to personnel of one role to personnel of another role. For example, persons 1006, 1008, and 1010 (of group 1002) may developers that are developing a database model, and persons 1012, 1014, and 1016 (of group 1004) may be database administrators (DBAs) that manage production databases. As shown in FIG. 10, a database model snapshot 1018 may be used to communicate a database model between the developers of group 1002 and the DBAs of group 1004 (e.g., to provide database model updates from group 1002 to group 1004, and/or to provide changes to the production databases from group 1004 to group 1002. As such, this illustrates the use of database model snapshots as a technique for communicating database model across security boundaries (e.g., where different security protocols exist in first group 1002 and second group 1004). Furthermore, as shown in FIG. 10, persons 1012, 1014, and 1016 may use database model snapshots to communicate database models between different production databases, etc.

Database model snapshots may be used as a format to communicate breaking database model changes across versions.

Database model snapshots may be captured as a production box to capture the database model of a running database as a proxy to send back to pre-production stages (e.g., development, quality assurance and validation, etc.). Such as database model snapshot may be used to calculate drift between the production version and the current development version of the database model. As described above, the database model snapshot may be used to generate a deployment plan to get one or more production versions of the database model upgraded to the current staged version in development.

Database model snapshots may be captured for a development box periodically at milestones. These database model snapshots may be used to capture and view a holistic database model view at various stages of development, as well as document how the database model has evolved during development.

As described in the prior subsection, database model snapshots may be used to compose a deployment plan for a database model by chaining together multiple snapshots and injecting custom user code in between them. The custom code may be of any type. The injected imperative commands may be used to influence the deployment of the database model.

Database model snapshots may be captured from a running database, and offline static analysis or other types of automated testing may be performed on the database model snapshots.

Database model snapshots may be captured from a running database and used as the data model when building a database application that will make use of an instance of the database model encoded in the snapshot.

As described above, a database model snapshot may be captured from a development source code project and checked in to a source control system for version and history tracking.

Furthermore, as described above, a database model snapshot may be captured from a running database and archived into a section of a catalog for visibility, version and history tracking.

Still further, a database model snapshot may be captured from a running database and used to deploy a copy, either in full or in part, either intact or manipulated in such a way as to obfuscate sensitive information, to the same or a different version and vendor of the running database.

It is noted that organizations do not always allow developers access to production database sites. Sometimes hot fixes are needed and made to a production database site directly to keep the database system live. This may lead to a situation where a production version of a database model drifts away from the original source database model. Communicating the changes made to the production database site back to the developer(s) becomes a real challenge, and a failure to do so risks regressing the same hot fixes. In embodiments, a database model snapshot may be captured from the production system that conforms to the enterprise business and security policies (e.g., no snapshotting of user data or obfuscation of any personal identifiable information (PII)). In an embodiment, a user may interact with a user interface to configure how a database model snapshot object is generated by database model snapshot generator 202. For instance, the user may select particular reference data, tables, and/or columns of the database mode to be excluded from the generated database model snapshot object.

Furthermore, database models frequently need to be communicated between personnel of the same role or across roles and/or across technologies. In some instances, text scripts are used to communicate database models between people, which may be a holistic model definition or a partial upgrade command script. Such scripts are not reader friendly to many commonly used management and productivity tools. In embodiments, database model snapshots may capture the details for complying with many tooling sets.

For instance, FIG. 11 shows a block diagram of database model snapshot object 210 being readable by a variety of different tools, according to an example embodiment. As shown in FIG. 11, database model snapshot object 210 may be read by each of a first tool 1102, a second tool 1104, a third tool 1106, and further tools not shown in FIG. 11. Because database model snapshot object 210 is transportable, human readable, and normalized (e.g., in XML form), database model snapshot object 210 may be read by each of tools 1102, 1104, and 1106 (and further tools), and viewed, edited, and/or otherwise processed by each of tools 1102, 1104, and 1106. Examples of tools 1102, 1104, and 1106 include commercially available browsers such as include Internet Explorer®, developed by Microsoft Corp. of Redmond, Wash., Mozilla Firefox®, developed by Mozilla Corp. of Mountain View, Calif., Safari®, developed by Apple Inc. of Cupertino, Calif., and Google® Chrome of Mountain View, Calif., tools used to compare schemas and/or data of different databases, such as Microsoft SQL Server Compare Tools (e.g., Comparer), tools that enable administrative tasks to be performed such as Microsoft Windows PowerShell (e.g., using cmdlets), word processing tools such as Microsoft® Word, and further types of commercially available application tools. By virtue of being a tooling friendly format and applicable to a variety of tooling ecosystems, productivity is promoted by the use of database model snapshots for many more different uses (e.g., for telemetry).

While database model snapshots provide a new and better means to communicate database model definitions over the “wire” (transported electronically), database model snapshots also embrace existing workflows. Users may generate database model definition scripts from a database model snapshot as well as generating upgrade scripts by comparing two database model snapshots representing different database model versions. Such derivative scripts from a database model snapshot can be deployed to embrace the traditional publishing workflow; or the database model snapshot may be published directly using appropriate tooling.

### III Example Computing Device Embodiments

Database model snapshot generator 202, database model snapshot generator 404, database model snapshot generator 404a, database model snapshot generator 404b, metadata capture module 406, snapshot object generator 408, snapshot comparator 410, snapshot comparator 410a, snapshot comparator 410b, snapshot post-processing module 702, source control system 704, deployment plan generator 708, snapshot testing module 710, deployment engine 902, script engine 904, flowchart 300, flowchart 500, and flowchart 800 may be implemented in hardware, software, firmware, or any combination thereof For example, database model snapshot generator 202, database model snapshot generator 404, database model snapshot generator 404a, database model snapshot generator 404b, metadata capture module 406, snapshot object generator 408, snapshot comparator 410, snapshot comparator 410a, snapshot comparator 410b, snapshot post-processing module 702, source control system 704, deployment plan generator 708, snapshot testing module 710, deployment engine 902, script engine 904, flowchart 300, flowchart 500, and/or flowchart 800 may be implemented as computer program code configured to be executed in one or more processors. Alternatively, database model snapshot generator 202, database model snapshot generator 404, database model snapshot generator 404a, database model snapshot generator 404b, metadata capture module 406, snapshot object generator 408, snapshot comparator 410, snapshot comparator 410a, snapshot comparator 410b, snapshot post-processing module 702, source control system 704, deployment plan generator 708, snapshot testing module 710, deployment engine 902, script engine 904, flowchart 300, flowchart 500, and/or flowchart 800 may be implemented as hardware logic/electrical circuitry. For instance, in an embodiment, one or more of database model snapshot generator 202, database model snapshot generator 404, database model snapshot generator 404a, database model snapshot generator 404b, metadata capture module 406, snapshot object generator 408, snapshot comparator 410, snapshot comparator 410a, snapshot comparator 410b, snapshot post-processing module 702, source control system 704, deployment plan generator 708, snapshot testing module 710, deployment engine 902, script engine 904, flowchart 300, flowchart 500, and/or flowchart 800 may be implemented together in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

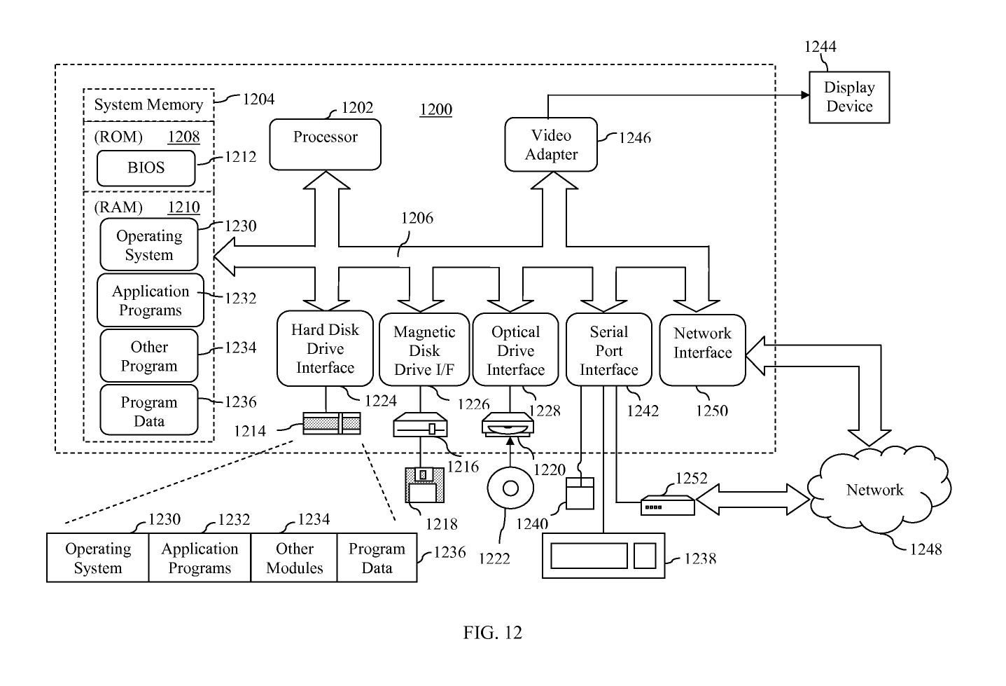

FIG. 12 depicts an exemplary implementation of a computer 1200 in which embodiments of the present invention may be implemented. For example, development computer system 204, server 206, and/or computer system 402 may be implemented in a computer system similar to computer 1200, including one or more features of computer 1200 and/or alternative features. Computer 1200 may be a general-purpose computing device in the form of a conventional personal computer, a mobile computer, a server, or a workstation, for example, or computer 1200 may be a special purpose computing device. The description of computer 1200 provided herein is provided for purposes of illustration, and is not intended to be limiting. Embodiments of the present invention may be implemented in further types of computer systems, as would be known to persons skilled in the relevant art(s).

As shown in FIG. 12, computer 1200 includes one or more processors 1202, a system memory 1204, and a bus 1206 that couples various system components including system memory 1204 to processor 1202. Bus 1206 represents one or more of any of several types of bus structures, including a memory bus or memory controller, a peripheral bus, an accelerated graphics port, and a processor or local bus using any of a variety of bus architectures. System memory 1204 includes read only memory (ROM) 1208 and random access memory (RAM) 1210. A basic input/output system 1212 (BIOS) is stored in ROM 1208.

Computer 1200 also has one or more of the following drives: a hard disk drive 1214 for reading from and writing to a hard disk, a magnetic disk drive 1216 for reading from or writing to a removable magnetic disk 1218, and an optical disk drive 1220 for reading from or writing to a removable optical disk 1222 such as a CD ROM, DVD ROM, or other optical media. Hard disk drive 1214, magnetic disk drive 1216, and optical disk drive 1220 are connected to bus 1206 by a hard disk drive interface 1224, a magnetic disk drive interface 1226, and an optical drive interface 1228, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1230, one or more application programs 1232, other program modules 1234, and program data 1236. Application programs 1232 or program modules 1234 may include, for example, computer program logic (e.g., computer program code) for implementing database model snapshot generator 202, database model snapshot generator 404, database model snapshot generator 404a, database model snapshot generator 404b, metadata capture module 406, snapshot object generator 408, snapshot comparator 410, snapshot comparator 410a, snapshot comparator 410b, snapshot post-processing module 702, source control system 704, deployment plan generator 708, snapshot testing module 710, deployment engine 902, script engine 904, flowchart 300, flowchart 500, and/or flowchart 800 (including any step of flowcharts 300, 500, and 800), and/or further embodiments described herein.

A user may enter commands and information into the computer 1200 through input devices such as keyboard 1238 and pointing device 1240. Other input devices (not shown) may include a microphone, joystick, game pad, satellite dish, scanner, or the like. These and other input devices are often connected to processor 1202 through a serial port interface 1242 that is coupled to bus 1206, but may be connected by other interfaces, such as a parallel port, game port, or a universal serial bus (USB).

A display device 1244 is also connected to bus 1206 via an interface, such as a video adapter 1246. In addition to the monitor, computer 1200 may include other peripheral output devices (not shown) such as speakers and printers.

Computer 1200 is connected to a network 1248 (e.g., the Internet) through an adaptor or network interface 1250, a modem 1252, or other means for establishing communications over the network. Modem 1252, which may be internal or external, may be connected to bus 1206 via serial port interface 1242, as shown in FIG. 12, or may be connected to bus 1206 using another interface type, including a parallel interface.

As used herein, the terms “computer program medium,” “computer-readable medium,” and “computer-readable storage medium” are used to generally refer to media such as the hard disk associated with hard disk drive 1214, removable magnetic disk 1218, removable optical disk 1222, as well as other media such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1232 and other program modules 1234) may be stored on the hard disk, magnetic disk, optical disk, ROM, or RAM. Such computer programs may also be received via network interface 1250, serial port interface 1242, or any other interface type. Such computer programs, when executed or loaded by an application, enable computer 1200 to implement features of embodiments of the present invention discussed herein. Accordingly, such computer programs represent controllers of the computer 1200.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### CONCLUSION

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method, comprising:
capturing metadata of a database model; and
generating a database model snapshot object based on the captured metadata, the database model snapshot object being transportable, extensible, secure, and human readable, and the database model snapshot object is exclusive of operational data.

2. The method of claim 1, further comprising:
using the generated database model snapshot object to communicate information regarding the database model between personnel.

3. The method of claim 1, wherein said capturing comprising:
capturing metadata of the database model of a running database application, a database source code development project, an entity relational diagram, a database model diagram, or a domain specific language script.

4. The method of claim 1, wherein said generating comprises:
generating the database model snapshot object in a form of an XML (extensible markup language) document.

5. The method of claim 1, wherein the database model is a database model of a production database system, said capturing comprising:
capturing metadata of the database model of the production database system;
said generating comprising:
generating a current database model snapshot object based on the captured metadata; and
the method further comprising:
comparing the current database model snapshot object to a previously generated database model snapshot object for the database model of the production database system to generate a database model change indication that indicates a database model change in the production database system.

6. The method of claim 1, wherein the database model is a database model of a development database system, said capturing comprising:
capturing metadata of the database model of the development database system;
said generating comprising:
generating a first database model snapshot object based on the captured metadata; and
the method further comprising:
receiving a second database model snapshot object that was generated based on metadata captured from a production version of the database model of the development database system; and
comparing the first database model snapshot object to the second database model snapshot object to generate a database model change indication that indicates a database model change in the production database system relative to the development database system.

7. The method of claim 6, further comprising:
generating a deployment plan based on the database model change indication.

8. The method of claim 1, wherein the database model is a database model of a development database system, said capturing comprising:
capturing metadata of the database model of the development database system;
said generating comprising:
generating a current database model snapshot object based on the captured metadata; and
the method further comprising:
comparing the current database model snapshot object to a previously generated database model snapshot object for the development database system to generate a database model change indication that indicates a database model change in the development database system.

9. The method of claim 1, wherein the database model is a database model of a development database system, the method further comprising:
checking the database model snapshot object generated for the database model of the development database system into a source control system for version and history tracking of the database model.

10. The method of claim 1, wherein the database model is a database model of a production database system, the method further comprising:
checking the database model snapshot object generated for the database model of the production database system into a catalog for visibility, version, and history tracking of the database model.

11. The method of claim 1, further comprising:
performing offline testing on the database model snapshot object.

12. A system, comprising:
a metadata capture module that captures metadata of a database model; and
a snapshot object generator that generates a database model snapshot object based on the captured metadata, the database model snapshot object being transportable, extensible, secure, and human readable, and the database model snapshot object is exclusive of operational data.

13. The system of claim 12, wherein the database model snapshot object is readable by a plurality of commercially available tools.

14. The system of claim 12, wherein the metadata capture module captures metadata of the database model of a running database application, a database source code development project, an entity relational diagram, a database model diagram, or a domain specific language script.

15. The system of claim 12, wherein the snapshot object generator generates the database model snapshot object in a form of an XML (extensible markup language) document.

16. The system of claim 12, further comprising;
a snapshot comparator;
wherein the database model is a database model of a production database system;
the metadata capture module captures metadata of the database model of the production database system;
the snapshot object generator generates a current database model snapshot object based on the captured metadata; and
the snapshot comparator compares the current database model snapshot object to a previously captured database model snapshot object for the database model of the production database system to generate a database model change indication that indicates a database model change in the production database system.

17. The system of claim 12, further comprising;
a snapshot comparator;
wherein the database model is a database model of a development database system, the metadata captured by the metadata capture module is metadata of the database model of the development database system, and the snapshot object generator generates a first database model snapshot object based on the metadata of the database model of the development database system;
the snapshot comparator receives a second database model snapshot object for a database model of a production database system that is a production version of the database model of the development database system; and
the snapshot comparator compares the first database model snapshot object to the second database model snapshot object to generate a database model change indication that indicates a database model change in the production database system relative to the development database system.

18. The system of claim 17, further comprising:
a deployment plan generator that generates a deployment plan based on the database model change indication.

19. The system of claim 12, further comprising;
a snapshot comparator;
wherein the database model is a database model of a development database system;
the metadata capture module captures metadata of the database model of the development database system;
the snapshot object generator generates a current database model snapshot object based on the metadata; and
the snapshot comparator compares the current database model snapshot object to a previously captured snapshot of the database model of the development database system to generate a database model change indication that indicates a database model change in the development database system.

20. A method for deploying a database model to a target system, comprising:
receiving a first database model snapshot object at a target system;
applying the first database model snapshot object to generate a target database model at the database system;
receiving a deployment script at the database system that includes at least one user provided imperative command;
applying the deployment script to the target database model to modify the target database model based on the at least one user generated imperative command;
receiving a second database model snapshot object at the target system; and
applying the second database model snapshot object to the modified target database model to further modify the modified target database model, any changes included in the first database model snapshot object and also contained in the second database model snapshot object not being applied during said applying the second database model snapshot object to the modified target database model.
